(19) United States
(12) Patent Application Publication
(10) Pub. No.: US 2008/0077411 A1
(43) Pub. Date: Mar. 27, 2008

(54) Decoder, signal processing system, and decoding method

(76) Inventors: Rintaro Takeya, Osaka (JP); Michihiro Matsumoto, Hyogo (JP)

Correspondence Address: MCDERMOTT WILL & EMERY LLP, 600 13TH STREET, NW, WASHINGTON, DC, 20005-3096, US

(21) Appl. No.: 11/902,236

(22) Filed: Sep. 20, 2007

(30) Foreign Application Priority Data
Sep. 22, 2006 (JP) 2006-257206

(51) Int. Cl. G10L 19/00

(52) U.S. Cl. 704/500

(57) ABSTRACT

A storage section is provided for storing a plurality of pieces of first code data. Further, an estimation section is provided for, when first code data used in decoding exists in a current frame to be decoded or the storage section, outputting the first code data, and when not, estimating first code data corresponding to the current frame to be decoded from one or more pieces of past or future first code data stored in the storage section and earlier or later than the current frame to be decoded, and outputting the estimated first code data.

### CROSS REFERENCE TO RELATED APPLICATIONS

This Non-provisional application claims priority under 35 U.S.C. §119(a) on Patent Application No. 2006-257206 filed in Japan on Sep. 22, 2006, the entire contents of which are hereby incorporated by reference.

### BACKGROUND OF THE INVENTION

1. Field of the Invention

The present invention relates to a decoder for decoding encoded data which includes two kinds of data, i.e., first code data appearing every several frames and second code data certainly appearing every frame, and is arranged to be decoded based on the two kinds of data.

2. Description of the Related Art

Audio data or the like may be encoded, transferred, or recorded into a recording medium in units of a set of data within a predetermined period of time (referred to as a frame).

For example, the AAC+SBR method is an encoding method which can transfer audio information ranging from a low band to a high band in a digital broadcasting or communications system using audio data including a low-band code portion having audio information about a low frequency band and a high-band code portion having audio information about a high frequency band. Note that AAC is an abbreviation of Advanced Audio Coding and SBR is an abbreviation of Spectral Band Replication.

In the digital broadcasting or communications system employing the AAC+SBR method, an event may occur in which a frame is not received or is inappropriately received (called frame loss).

When a frame is lost in this manner, original data cannot be normally decoded. Therefore, in some conventional devices, a first frequency band which was able to be normally received (e.g., a low frequency band) is decoded, and a second frequency band which was inappropriately received and cannot be decoded without modification (e.g., a high frequency band) is estimated (reconstructed) from a first decoded frequency band of the previous frame which was able to be normally decoded while referencing audio data in a second decoded frequency band of the frame (see, for example, Japanese Unexamined Patent Application Publication No. 2005-24756).

In the conventional device, when a period of time in which decoding cannot be normally performed is momentary, decoded data of interest can be estimated with relatively high accuracy. However, when a period of time in which decoding cannot be normally performed continues, the accuracy of estimation is deteriorated, thereby making it difficult to obtain a desired effect.

In some encoding methods in which encoding is performed in units of frames, data having a structure including two kinds of data, i.e., first code data appearing every several frames and second code data certainly appearing every frame, is used. In those methods, encoded data is decoded into original data using the two kinds of encoded data. For example, the SBR method which is used to encode audio information in a high frequency band of audio data in the AAC+SBR method is one of those methods.

In the SBR method, information called sbr_header (corresponding to the first code data) is required for decoding, but the sbr_header information does not necessarily appear every frame. Therefore, when a frame including sbr_header is lost, a period of time in which decoding cannot be normally performed continues until a new sbr_header appears.

Also, sbr_header information (the first code data) used in decoding may not be obtained immediately after a frame is skipped (e.g., fast forward, rewind, etc.). In this case, a period of time in which decoding cannot be normally performed may also continue. For example, when sbr_header information is not inserted for a long period of time (e.g. one minute), decoding of the SBR method cannot be normally performed for as long as one minute.

### SUMMARY OF THE INVENTION

In view of the above-described problems, the present invention has been achieved. An object of the present invention is to provide a decoder (e.g., audio codec) in which, when encoded data including two kinds of data, i.e., first code data appearing every several frames and second code data certainly appearing every frame, is decoded, continuation of a period of time in which decoding cannot be performed is prevented even if first code data used in decoding is not obtained.

To achieve the object, an embodiment of the present invention is a decoder for decoding encoded data having a structure including two kinds of data, i.e., first code data appearing every time every several frames and second code data certainly appearing every frame, and arranged to be decoded based on the two kinds of data, comprising a storage section for storing a plurality of pieces of the first code data, an estimation section for, when the first code data corresponding to a current frame to be decoded exists in the current frame to be decoded or in the storage section, outputting the first code data, and when not, estimating first code data corresponding to the current frame to be decoded from one or more pieces of past or future first code data stored in the storage section and earlier or later than the current frame to be decoded, and outputting the estimated first code data, and a construction section for constructing decoded data based on first code data output by the estimation section and second code data included in the current frame to be decoded.

### BRIEF DESCRIPTION OF THE DRAWINGS

FIG. 1 is a block diagram showing a configuration of a decoder 100 according to an embodiment of the present invention.

### DETAILED DESCRIPTION OF THE PREFERRED EMBODIMENTS

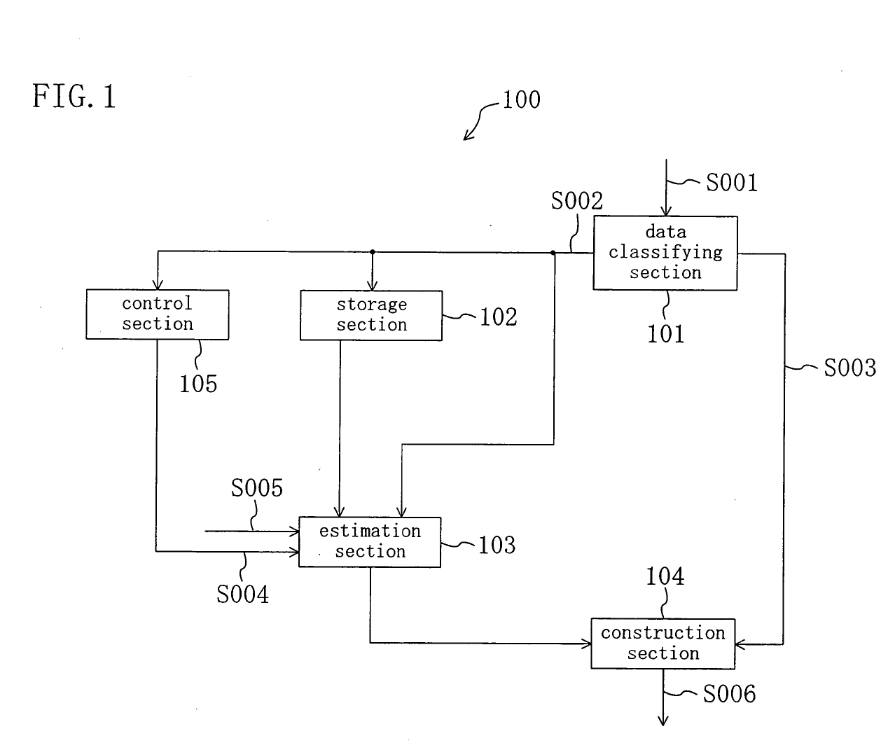

FIG. 1 is a block diagram showing a configuration of a decoder 100 according to an embodiment of the present invention. The decoder 100 is an exemplary device for decoding audio data (audio data S001) encoded by the SBR method and outputting the resultant data. The decoder 100 can be combined with an output unit (e.g., an amplifier, and may further include a loudspeaker) or the like so as to construct a signal processing system (e.g., an audio player). Note that audio data encoded by the SBR method includes first code data appearing every several frames (sbr_header information) and second code data certainly appearing every frame.

[Configuration of Decoder 100]

As shown in FIG. 1, the decoder 100 comprises a data classifying section 101, a storage section 102, an estimation section 103, a construction section 104, and a control section 105.

The data classifying section 101 classifies and outputs audio data S001 into first code data S002 and second code data S003.

The storage section 102 holds a plurality of pieces of first code data S002 output by the data classifying section 101.

The estimation section 103 outputs first code data S002 which will be used to decode a current frame to be decoded. Specifically, when first code data S002 exists in a current frame to be decoded, the first code data S002 is output as it is.

Also, when first code data S002 does not exist in a current frame to be decoded and first code data S002 corresponding to the current frame to be decoded exists in the storage section 102, the first code data S002 corresponding to the current frame to be decoded exists in the storage section 102 is output as it is.

Also, when first code data S002 corresponding to a current frame to be decoded does not exist in the current frame to be decoded or in the storage section 102 (e.g., when first code data S002 was not able to be correctly received (e.g., the first code data S002 was lost), when first code data S002 corresponding to a current frame to be decoded is skipped during fast-forward playback, when first code data S002 corresponding to a current frame to be decoded is not reached or is skipped during playback while rewinding, etc.), first code data S002 held in the storage section 102 is used to estimate the first code data S002 corresponding to the current frame to be decoded (described below) and outputs the estimated first code data S002. Note that the presence or absence of first code data S002 corresponding to a current frame to be decoded in the storage section 102 is detected by the control section 105, and code data detection information S004 indicating the result is notified to the estimation section 103.

For the estimation of first code data S002 in the storage section 102, data to be used in the storage section 102 varies depending on whether a playback operation is forward playback (normal playback or fast-forward playback) or backward playback (playback while rewinding).

Specifically, the estimation section 103 receives playback indication information S005 indicating a playback state (normal playback, fast-forward playback, and playback while rewinding). When the playback indication information S005 indicates forward playback, first code data S002 corresponding to a past frame earlier in the time series than a current frame to be decoded is used for estimation. When the playback indication information S005 indicates backward playback, first code data S002 corresponding to a future frame later in the time series than a current frame to be decoded is used for estimation.

In this embodiment, as the estimation method in the estimation section 103, when forward playback is performed, a method is employed in which past first code data S002 which has been obtained most recently is read out, as it is, from the storage section 102 and is set as estimated first code data. When backward playback is performed, a method is employed in which future first code data S002 which has been obtained most recently is read out, as it is, from the storage section 102 and is set as estimated first code data. In the SBR method, sbr_header information equivalent to first code data is highly likely to be completely the same between the same songs. Therefore, there is not a problem even when first code information which has been stored most recently is simply used as code information corresponding to a current frame to be decoded.

The construction section 104 uses first code data S002 output by the estimation section 103 and second code data S003 output by the data classifying section 101 to decode a current frame to be decoded and outputs the result as output audio data S006.

The control section 105 controls the storage section 102 and the estimation section 103. Specifically, the control section 105 updates data held in the storage section 102 every time the data classifying section 101 outputs first code data S002. The control section 105 also detects whether or not first code data S002 corresponding to a current frame to be decoded exists in the storage section 102, and outputs code data detection information S004 indicating the result to the estimation section 103.

[Operation of Decoder 100]

(Operation During Normal Playback or Fast-Forward Playback)

The data classifying section 101, when receiving audio data S001, classifies audio data S001 into first code data S002 and second code data S003, which are then output. The control section 105 updates first code data S002 held in the storage section 102 with first code data S002 output by the data classifying section 101.

Here, playback indication information S005 input to the control section 105 indicates that a playback state is normal playback or fast-forward playback (i.e., forward playback). Therefore, when first code data S002 corresponding to a current frame to be decoded exists in the current frame to be decoded or in the storage section 102, the estimation section 103 outputs the first code data S002 as it is.

On the other hand, when first code data S002 corresponding to a current frame to be decoded does not exist in the current frame to be decoded or in the storage section 102, the estimation section 103 reads out first code data S002 corresponding to a past frame earlier than the current frame to be decoded from the storage section 102 and outputs the first code data S002 to the construction section 104. Thereby, the construction section 104 uses first code data S002 output by the estimation section 103 and audio data S001 output by the data classifying section 101 to decode a current frame to be decoded and outputs the result as output audio data S006.

(Operation During Playback while Rewinding)

During playback while rewinding, if first code data S002 corresponding to a current frame to be decoded remains in the storage section 102, the estimation section 103 outputs the remaining first code data S002, and if not, the estimation section 103 reads out first code data S002 corresponding to a future frame later in the time series than the current frame to be decoded from the storage section 102 and outputs the first code data S002 to the construction section 104. Thereby, the construction section 104 uses first code data S002 output by the estimation section 103 and audio data S001 output by the data classifying section 101 to decode a current frame to be decoded and outputs the result as output audio data S006.

As described above, according to this embodiment, when first code data corresponding to a current frame to be decoded is not obtained, past or future first code data in the time series is used to estimate first code data corresponding to the current frame to be decoded, thereby making it possible to prevent continuation of a period of time in which decoding cannot be performed. Therefore, audio data can be reproduced with quality which is intended by a content producer.

In addition, it is easier for the estimation section 103 to estimate first code data than decoded data. Therefore, the decoder 100 can be implemented with a relatively small scale as compared to the conventional art.

Note that the estimation section 103 may use a plurality of pieces of first code data S002 in the storage section 102 so as to estimate first code data S002 corresponding to a current frame to be decoded. Specifically, for example, a plurality of pieces of first code data are stored in the storage section 102, and a piece of first code data is selected from these pieces of first code data by majority decision, and the selected first code data is set as estimated first code data.

The parts of the embodiment above may be implemented either by hardware or software.

The present invention is not limited to audio data encoded by the SBR method illustrated above and is also applicable to any encoded data which includes two kinds of data, i.e., first code data appearing every several frames and second code data appearing certainly appearing every frame, and is encoded based on the two kinds of data.

As described above, in the decoder of the present invention, assuming that encoded data including two kinds of data, i.e., first code data appearing every several frames and second code data appearing certainly appearing every frame, is decoded, when first code data corresponding to a current frame to be decoded is not obtained, past or future first code data in the time series is used to estimate first code data corresponding to the current frame to be decoded so as to perform decoding. Therefore, even when first code data used in decoding is not available, it is possible to prevent continuation of a period of time in which decoding cannot be performed. Therefore, the present invention is useful as a decoder for decoding the encoded data, a signal processing system using the decoder, or the like.

What is claimed is:

1. A decoder for decoding encoded data having a structure including two kinds of data, i.e., first code data appearing every time every several frames and second code data certainly appearing every frame, and arranged to be decoded based on the two kinds of data, comprising:
a storage section for storing a plurality of pieces of the first code data;
an estimation section for, when the first code data corresponding to a current frame to be decoded exists in the current frame to be decoded or in the storage section, outputting the first code data, and when not, estimating first code data corresponding to the current frame to be decoded from one or more pieces of past or future first code data stored in the storage section and earlier or later than the current frame to be decoded, and outputting the estimated first code data; and
a construction section for constructing decoded data based on first code data output by the estimation section and second code data included in the current frame to be decoded.

2. The decoder of claim 1, wherein
the estimation section outputs, as the estimated first code data, first code data selected from the plurality of pieces of first code data by majority decision.

3. The decoder of claim 1, wherein
the estimation section outputs, as the estimated first code data, past or future first code data obtained most recently.

4. A signal processing system comprising:
the decoder of claim 1;
an input section for receiving encoded audio data having a structure including two kinds of data, i.e., first code data appearing every time every several frames and second code data certainly appearing every frame, and arranged to be decoded based on the two kinds of data, and outputting the encoded audio data to the decoder; and
an output section for outputting decoded audio data generated by the decoder as an audio signal.

5. A method for decoding encoded data having a structure including two kinds of data, i.e., first code data appearing every time every several frames and second code data certainly appearing every frame, and arranged to be decoded based on the two kinds of data, comprising:
a storage step of storing a plurality of pieces of the first code data into a storage section;
an estimation step of, when the first code data corresponding to a current frame to be decoded exists in the current frame to be decoded or in the storage section, outputting the first code data, and when not, estimating first code data corresponding to the current frame to be decoded from one or more pieces of past or future first code data stored in the storage section and earlier or later than the current frame to be decoded, and outputting the estimated first code data; and
a construction step of constructing decoded data based on first code data output by the estimation section and second code data included in the current frame to be decoded.
